(19) United States
(12) Patent Application Publication
(10) Pub. No.: US 2012/0144133 A1
(43) Pub. Date: Jun. 7, 2012

(54) METHOD AND SYSTEM FOR STORAGE AND EVALUATION OF DATA, ESPECIALLY VITAL DATA

(75) Inventor: Jörg Walter, Grafing (DE)

(73) Assignee: VITAPHONE GMBH, Mannheim (DE)

(21) Appl. No.: 13/389,715

(22) PCT Filed: Aug. 24, 2010
(86) PCT No.: PCT/EP10/05162

§ 371 Date: Feb. 9, 2012

(30) Foreign Application Priority Data
Aug. 24, 2009 (DE) 10 2009 038 391.3
Dec. 23, 2009 (DE) 10 2009 060 553.3

(51) Int. Cl. G06F 12/00

(52) U.S. Cl. 711/154; 711/E12.001

(57) ABSTRACT

A method for evaluation and aggregating storage of data, especially multivariate time series, such as sensor and vital data, the data being acquired via at least one sensor (2) and being stored by a computer unit (3) of a user device (4) and being aggregated in resolution stages which are hierarchical in time. The stored data can be selectively retrieved from an external evaluation device (5). A particular feature lies in preparing both high resolution data (possibly raw data) if interest for retrospective analysis (and training data procurement for machine learning methods) is latent, and also multiscale outline data for integral examinations, ad hoc analyses and exploratory data mining.

### BACKGROUND OF THE INVENTION

1. Field of the Invention

This invention relates to a system for the preparation, aggregation, storage, management and relay of data. This system is also called intelligent DataStore below. It typically has a so-called “embedded system” at the user device which receives data from one or more sensors or sensor systems for which it implements data warehouse functionalities. It is typically placed near the sensors in terms of information technology and space (or integrated in the sensor system) and corresponds to an evaluation device which retrieves the data episodically (from time to time) as a whole, but generally in parts in order to enable both systematic and also prompt ad-hoc analyses (visualizations and interactive navigation) and other data processing steps (data mining).

2. Description of Related Art

The availability of favorable computing power, storage capacity and economical sensors enables numerous newer and newer applications which contain the processing and analysis of long signal recordings. Portable, battery-operated systems or user devices can record sensor signals, analyze them, and optionally relay them autonomously via a radio link to a receiving unit or evaluation device which manually or automatically processes the data further.

For example, in the field of telemedicine, vital data, such as the EKG signal, are of great importance for cardiac monitoring and diagnostics. Holster EKGs are worn for 24 hours and the entire data set is archived. Event and loop recorders are worn for a longer time in order to detect arrhythmias and transmit short-term EKG in digital form.

Evaluation of a holster EKG or other longer data sets tends to be complex. It is conventional to transmit, view and evaluate the entire data set on an evaluation system. Furthermore, the running time and/or resolution of these systems is limited. Event and loop recorders can be worn longer, especially against the background that a recording is activated (for example brachycardia detection with a heart rate greater than 160 bpm) only based on a predefined metric of interest, especially certain threshold values or state change. This method however prevents the relevant time ranges before advent of a triggering event from being evaluated.

Later correlation analyses, trend analyses, analyses of EKG signals or of other data can be especially illuminating when further information is available, such as for example changes of mental state, medication changes and other conspicuous signal recordings. Signal storage and transmission to the analysis unit of the evaluation device are necessary. Thus it is necessary that for these methods suitable data sets are available; this is generally not the case for event and loop recorders. Moreover, for these methods, the entire data set with a correspondingly large volume of data must be transmitted. This is especially dependent on the available data transmission rate or bandwidth, and is time-consuming and costly.

Digital memories are prominent nowadays. Transmission takes place in three ways: (i) media exchange (memory chip, previously cassettes); (ii) over cable (for example, USB connection) or (iii) wirelessly.

The advantages of the wireless radio link are better device encapsulation (requirements with respect to tightness, ability to be cleaned, and electrical insulation) and greater convenience (device can remain on site, no cable entanglement, no memory card logistics). The disadvantages of the radio link consist for example in the risk that data transmission is not always reliably available (interference, channel occupancy, network coverage), in high energy consumption (depending on the range), in the bandwidth limitation which arises (thus the practical time demand) and optionally additional data transmission charges (for example GSM/UMTS). The power consumption limits the battery life and battery charging or battery exchange cycles and influences the utility of the system.

In a conventional sensor data measurement system the practical problems are as follows:

there is a latent interest in data availability in high signal resolution, for example, for comparison of the most recent signal recordings (real-time) with certain historical data. In fact, from time to time, only a very small part of signal observation is evaluated which is, however, unclear beforehand.

With time very large amounts of data occasionally arise which must be transmitted and stored to be available for evaluation on an evaluation system (computer system, optionally distributed).

Evaluations are, of course, only possible when the data have been transmitted beforehand. Thus, prompt ad-hoc evaluations are only possible when all relevant data are periodically or continuously transmitted on a preventive basis; this leads to the aforementioned transmission costs for large amount of data—regardless of whether it is used or not.

The data retention costs (for example, in a data center, especially when archiving and/or further processing and/or evaluation are mandated) and the transmission costs can quickly become burdensome and motivate the user to turn off or fundamentally not use “expensive” data transmission.

### SUMMARY OF THE INVENTION

An object of the invention is to handle and/or transmit “only the interesting” data, and the exact definition of “interesting” only arises in the course of evaluation so that it can shift completely, and thus, hardly foreseeable data extracts are required.

Under the comprehensive code word “intelligent DataStore,” this invention avoids the unnecessary and possibly prohibitive transmission costs and waiting times of the prior art, and thus, offers great advantages in resource-limited applications.

The intelligent DataStore system stores data, typically digitized sensor measurement signals, (in terms of information technology) near the data source (for example on nonvolatile flash memories). The analog and digital components of sensor signal preprocessing can also be combined with the intelligent DataStore in an overall system. Alternatively, the signals can also be received partially via cable or wirelessly from another digital data delivery system (for example, GPS module) instead of from one or more sensors.

Preferably, this data storage takes place in a battery-operated system or user device which can preferably be operated independently of the grid or on a mobile basis. The user device is therefore especially transportable.

Moreover, the data are aggregated contemporarily and especially in a form hierarchical in time, particularly in the user device, i.e., they are prepared for hierarchical data navigation such that they can be read out from the evaluation unit via a digital interrogation interface in diverse forms which are compressed semantically and/or in time.

The overall system allows interactive navigation via the evaluation device in large amounts of data on the intelligent DataStore near the sensor.

It supports so-called drill-down possibility in hierarchically aggregated data. If, for example, data domains defined by visual inspection are found to be of interest, the next higher resolution stage is read out and displayed (by an interrogation). Therefore, data are especially preferably stored and/or available in the user device in a second, preferably also a third aggregation stage. Analysis of derived attributes can preferably be combined.

Aggregation of recorded data can be done in diverse ways. In particular, recorded raw data are suitably abstracted by one method. Preferably, the abstraction yields a representative outline about the raw data without, however, their being discarded. Thus, in addition to the raw data, there is a first data set of aggregated data.

With the same or another method, it is now possible to aggregate the already aggregated data once again. In this way, it is possible to obtain different aggregation levels which preferably have a reduced amount of data with increasing aggregation stage and in this way to enable an overview.

With reference to the transmission of data from a user device to an evaluation unit, this means that the entire data set need not necessarily be transmitted. In contrast, the described aggregation enables a hierarchical access to the data.

For example, for a first data request not all the raw data or only an extract of these raw data is transmitted, but aggregated data, especially data of the highest or a higher aggregation level or with the smallest or smaller data volume, are transmitted. In the next step it is possible to request more detailed data, preferably a lower or an extract of a lower aggregation level. Thus, a more detailed evaluation or analysis of certain or especially interesting data domains is possible without having to transmit the entire data set. The described method can be continued as far as the raw data and corresponds to the aforementioned drill-down method for access to the hierarchically aggregated data.

With reference to the aggregation of data, it is possible to use different methods or to combine them with one another. Thus, in accordance with the invention, it is possible to alternatively or cumulatively apply different aggregation methods to a set of raw data. These methods can, in turn, likewise have different aggregation levels.

The data volume decreases with increasing aggregation. Therefore, it is possible to present the data aggregated in several stages as pyramids, preferably the raw data with the largest data volume representing the base of the pyramid and on this basis a reduced data volume accompanying each aggregation stage or level. Applied to several aggregation methods this means that based on the same raw data there can be several such aggregation pyramids.

Furthermore, it is possible that, for different methods, there can also be a different number of aggregation stages. Moreover, it also is possible to combine different aggregation methods within one aggregation pyramid or aggregation hierarchy.

Depending on the application and signal, specific time/semantic aggregations can be used:

One possibility of aggregation is time subsampling and/or digital filtering. Subsampling with references to simple time signals generally designates methods in which the signal is sampled at less than twice the bandwidth of the highest frequency which occurs. This subsampling can be carried out both during a digitization process and also later based on an already digitized signal. If signal frequencies are above twice the sampling frequency, the result is no longer unequivocal, especially since frequencies above twice the sampling frequency in the digital signal appear as a difference frequency at half sampling frequency. With reference to the aggregation, it is possible by subsampling to further evaluate the signal in spite of the ambiguity, for example, via pattern analysis. In this respect, methods for subsampling have analogies to compression methods or compression methods can have subsamplings.

Another class of aggregation methods uses compression of data (among others subject to loss) matched to the (sensor) signal in order to obtain signal features as relevant as possible. For example, it is possible to obtain or discard an especially adjustable portion of information per time interval with methods based on a wavelet transform, discrete cosine transform (DCT) or the like. Here, it is preferable to use methods, such as subsampling, statistical analysis, computation of derived signal descriptions, nonlinear transforms, especially FFT, DCT, wavelet transform, each especially with compressive thinning-out, and/or methods of machine learning. In addition to extreme value methods, there are various other compression methods for data aggregation which are, however, known to one skilled in the art and which do not require more detailed explanation.

Alternatively or additionally, it is possible to use peak levels or maximum value-base compression methods to determine for example maxima and minima of a signal characteristic, especially within a certain time interval. Depending on the size of the time interval and/or the accuracy of the representation of the extreme value, a hierarchial aggregation can be easily achieved via this compression method.

Statistical descriptions (mean values, standard deviation, higher moments, histograms, optionally also periodograms, Poincare plots) are other preferred methods for aggregation of signals. By data reduction, statistical methods also lead to a compression which can be especially likewise subject to losses. Statistical descriptions or statistical methods can however be advantageously with deviation used to localize data regions which can simplify or enable an evaluation.

Classification of the signal in categories to achieve a semantic description and thus estimation of the processes in the time interval. For this purpose, techniques and methods of machine learning (compare, U.S. Patent Application Publication 2010/0191685 A1) can be used.

Moreover, the measurement quality and the state and context of the measurement system can be assessed and noted (for example, electrical contact assessment).

These steps can be carried out in a computation- and memory-efficient manner near the end of given time intervals (for example, minute, hour, day, etc.), preferably, in this way, to later enable a high-performance interrogation—especially also without transmitting the raw data.

The (raw) data in high time resolution are preferably not discarded in the invention, but are kept available as long as possible and as long as wished. If a defined upper limit of the memory capacity is reached, old memory-intensive signal data (on request with the exception of random samples and higher aggregation steps) are successively erased and replaced by newer data.

Preferably, the aggregation or evaluation of data is done at least essentially already in the (transportable and/or grid-independent) user device. Advantageously, it is thus possible to use already preprocessed data in the course of evaluation. In this way, a significant time advantage and/or data processing advantage can be achieved. Interest is limited to survey information, details in the “raw data” (or high resolution data) need not be transmitted. This saves not only transmission effort (time, optionally energy, line costs), but for vital data of an individual protects his privacy in addition.

Data with high resolution in time, potentially, contain information which can be used to improve personal system and behavior profiles. If use is appropriate and arranged, the subsequent availability of detail data can be of great value, for example for the training of specialized behavior change detectors (for example, emergency detectors) or the retrospective analysis of creeping processes of change. The intelligent DataStore can keep data, especially also high resolution or raw data, available, and can later satisfy a latent interest. For protection against abuse, suitable protective measures for access can be taken. For a survey-like evaluation, the proposed method consequently offers several major advantages. Another advantage arises by the described, especially interactive and/or exploratory drill-down process for preferably staggered access to data of different aggregation stages, as explained at the beginning.

The number of aggregation levels to be computed in the user device, the number of aggregation methods which are in particular combined with one another or are used in parallel, and the choice of the methods for aggregation can be dependent in accordance with the invention due to preset priorities, by available computing power, by an internal status and/or on in what charging state the user device is and/or how the line profile has been configured. The charging state is relevant especially for an autonomous user device, therefore a user device which is independent of the power grid and/or of a wire or continuous wire connection.

Prioritization of different aggregation methods, their combination and aggregation depth can be, for example, influenced in that for mobile operation or for a low charging state few or less computation-intensive aggregation methods are used or the number of aggregation levels is limited or the aggregation depth is reduced. Thus, it is possible in accordance with the invention to select the aggregation method from a plurality of aggregation methods and/or to accordingly widen the aggregation depth for the case of a good charging state or for grid operation and especially in this case to also use complex and/or computation-intensive methods.

Preferably, the user device has an energy storage, such as a battery. In this way, autonomous or mobile operation of the user device can advantageously be enabled. Furthermore, the user device preferably has a device for determining the charging state of this energy storage. In accordance with the invention, it is possible that the computer unit of the user device receives information about the charging state from this device and depending on this information, especially depending on a decision-making criterion, such as a threshold value, carries out the described selection of aggregation methods which is dependent on the charging state from a plurality of aggregation methods.

An aggregation, preprocessing, analysis of data are already advantageous in the user device even against the background that a relatively large amount of time is available during the recording of data. But, in an evaluation, the necessary information should be available as directly as possible. Therefore, preprocessing in the user device can be implemented in a power-saving manner when corresponding computations take place slowly and/or with low clock rates.

The intelligent DataStore is typically interrogated by a corresponding processing system/evaluation device for purposes of (ad-hoc) display and analysis.

When special states are reached or certain events (for example, critical vital states) occur the intelligent DataStore can, alternatively or additionally, also actively send a message to the evaluation device or a responsible central site (for example, telemedicine service center). To ensure system availability, a regular “alive” report (similar to a “dead man's switch”), especially in conjunction with a battery state report, can be arranged or provided.

In conventional event recorders, it is possible to predefine a reaction to a certain event. In the system in accordance with the invention, the aggregated data can also be advantageously used to trigger corresponding events based thereon. For example, sensor data are acquired by the user device and are stored by the computer unit. At certain time intervals, an aggregation method can be used to aggregate the recorded data of the past interval. Aggregation methods can be analysis methods, can comprise analysis methods as part thereof or can enable an analysis. Consequently, the aggregation of raw data can lead to a certain event or state change being able to be automatically identified by use of an aggregation method. Preferably, it is possible to use this information to initiate an action in the user device.

The computer unit of the user device, for example, in the course or in alternation with a use of an aggregation method, can compare already aggregated data with a predefined interest matrix or an evaluation criterion. If this criterion or this interest matrix is satisfied, a predefined reaction of the user device can be initiated. For example, the user device in this case can mark the subset of data in which a criterion or an interest matrix is satisfied. Furthermore, a state change can be retrievably stored or actively signaled especially by the evaluation device. Signaling can for example be an alert signal such as a light signal or acoustic signal. But, the user device can also contact a responsible central site such as a telemedicine service center especially over a radio link such as a cell phone link, especially in order to initiate an alert there with respect to the detected state change.

It is possible for the central site or also the user device to contact an evaluation device as a result of a state change and/or to send corresponding information such as an alert to an evaluation device.

Data patterns, as criterion for detecting a state change, in this connection, are also called derived features, digital fingerprints or fingerprints. Advantageously, with the system in accordance with the invention, it is possible to not only define these fingerprints beforehand, but also to fix them afterwards. Thus, it is possible to transmit a corresponding digital fingerprint to a user device after recording, and to carry out the analysis based on the digital fingerprint on the user device, especially with the aggregated data. A response can thus take place specifically and/or aggregated. This method is therefore especially advantageous in data links with a limited bandwidth, especially radio links or cell phone links. A digital fingerprint can, in accordance with the invention, preferably be a condition, several conditions and/or a combination of conditions. These conditions can also, at the same time, relate to data of several independent sensors.

In one preferred embodiment, the method in accordance with the invention is interactive, therefore preferably allows inquiries, and especially dynamic reactions to these inquiries.

If a state change is recognized by an especially predefined interest metric, such as, for example, a threshold value or a digital fingerprint, the system can react differently. It is possible to record the state change for a later evaluation, or also to react actively to it or draw attention to it, especially by an acoustic or optical alert or by sending a message. The latter can preferably take place wirelessly, especially via the cell phone network.

The evaluation system can communicate via cable or radio using mechanisms suitable for secure communication (including suitable authorization and authentication methods) with the intelligent DataStore (especially via XML messages).

Data transmission by means of media change, especially by the exchange of memory cards, is comparatively complex and subject to wear. Therefore, there is data transmission by means of media change preferably only when a security copy is to be prepared, the existing memory is not sufficient and/or there is a possible defect.

For ad-hoc interrogations, especially as an evaluation unit, for example, a mobile device connected preferably via Bluetooth, Zigbee or another wireless communication method, such as a PDA, smart phone or notebook, preferably with special navigation and analysis software, can be used, and preferably, supports incremental analysis methods (for example, visual data mining).

For interrogation of the especially aggregated data from the user device, for the respective transmission method, standardized protocol frameworks can be combined with system-specific inquiries, which enables especially a hierarchical navigation through the data, especially with the described drill-down procedure.

The interrogation protocol preferably comprises some generic inquiries for the following:

list of data types and available data sets and/or

a real time data stream (with minimum latency time and definable resolution) and/or

sequence of raw signal or derived data within an interval (according to local time or Ids). The response is specific to the data type.

frequencies of derived data within interrogation intervals (for example, classified arrhythmia types per minute, hour, day, etc.)

The copying of data sets in a so-called “caching proxy” and the use of one are preferably supported, likewise the interrogation of system states and commanding of erasure process and aggregation parameters.

If the computing capacity of the intelligent DataStore allows it, the interrogation, in addition to XML-based or other formulations, can also be supported in a SQL-type inquiry. Thus, more complex restrictions and selections of the response data set can be especially effectively formulated in order to quickly identify data regions of interest (see, for example, sqlite.org). However, in accordance with the invention, it is also possible to apply other data architectures and/or access methods to these database structure.

The invention can be used for a plurality of signal data. The use in the domestic environment and in the vital data domain is preferable. Thus, for EKG signals, the following interrogations can be carried out, for example, individually or in any combination:

near-real time EKG signal

raw signal from time stamp from . . . to . . .

signal in resolution . . . from . . . to . . .

tachogram=heart rate (HR) from . . . to . . . per . . . (minute, hour, . . . )

HR

HR standard deviation

HR histogram (% of time HR between 60 . . . 70 bps,/70.80 bps, . . . )

number of beats in beat class (normal, extrasystoles, . . . )

Examples of sensors are the following:

Activity sensors, acceleration sensors, pedometer, smart metering sensors, consumption sensors for ADL (activity of daily life), presence sensors, PIR (passive infrared) sensors, pressure sensors especially for floor, bed and/or sitting occasion, sensors for humidity, stress and other psychological states (skin impedance), strain sensors, acoustic sensors (respiration noise, ambient noise, etc.) as well as light, motion, distance, magnet, contact, closing state, noise and/or gas sensors.

These sensors can be used individually or in different combinations with one another, and data of several sensors can be used to obtain or generate other data and/or information from the measurement data.

Examples of data to be measured include the following:

Vital data, EKG signals (see above), also in combination with a vest and defibrillators, EEG, temperature, pressure (plethysmograph (for example, chest volume estimate)), consumption data (energy and flow rates: current, gas, water), motion data, (3D to 6D) acceleration data, especially determined by accelerometers and gyrometers, ambient data (air pressure, especially determined by an altitude barometer, location, position), location data (GPS, radio cell IDs).

Examples of derived data are (among other) estimates about states, processes, or activities, ADL (activity of daily life) and participants.

Some details of this invention will be explained more precisely below using an electrocardiogram (EKG).

One preferred exemplary embodiment has a user device and an evaluation device. The user device is preferably located in the vicinity of a patient and can be operated independently of the grid. The user device can have a housing which can be stored in a pants pocket, coat pocket or shirt pocket. Furthermore, it is especially preferred to integrate the user device in a belt, since this enables connection of sensors to the user device in an especially simple and still effective manner. Other embodiments support the simple installation in spaces.

The user device can have different sensors or can be connected to them. In particular, a connection to the aforementioned sensors is possible. The user device also has a computer unit which can detect, process and/or store sensor data. For this purpose, the computer unit preferably has a memory region or the computer unit is assigned a memory. This memory region is especially preferably implemented by flash memories, but can also have a hard disk or other memory.

The user device of the system in accordance with the invention, especially an EKG system, also has an interface to the evaluation device. It can have especially a radio link, such as a cell phone link or a wire interface. Advantageously, a radio link is possible to access sensor data even on a mobile basis.

The evaluation device preferably has a display unit such as a display screen. Data transmitted by the user device or from the user device can preferably be displayed on this display.

For a recording, especially an EKG, one metric of interest can be divided into triggers, its derivatives, a combination of them and a mass of noninterest. Known triggers include values for tachycardia, bradycardia, atrial fibrillations, ventricular fibrillations and the (total) activity and the pause of the activity of the patient.

Derivatives can be formed from these triggers. In particular it is possible to form activity integrals. Conclusions regarding heart rate variability and heart rate turbulence are possible. The activity of a patient can be divided, for example, into the lying and sitting position or the daily activity. Furthermore, it is also possible to use location information, such as GPS information or signals from inertial sensors. Moreover, any combination of preset triggers and their derivatives is possible. Fingerprinting or digital fingerprint can constitute a combination of them.

In addition to the cited examples, for the interest metric, there are also criteria which militate against a state change and point to an absence of interest. Thus, there are known constellations of sensor signals which also indicate a faulty measurement. High activities of the chest musculature and also mechanical loads can lead to noise signals. For example, the movements in brushing teeth can lead to the derived EKG signal being similar to that in an atrial fibrillation. A corresponding possible faulty measurement can however be detected by additional sensors using the activity of the patient.

A system in accordance with the invention is preferably made such that it can react to one or more triggers or to one of more of their derivatives and/or to a digital fingerprint. For example it is possible to trigger an alert when a certain heart rate is exceeded in combination with low activity. This alert can comprise signaling by the user device, notification of the evaluation device and/or other receiving device and storage of the event.

In accordance with the invention, aggregation takes place, especially in the user device. Aggregations underlie preferably raw data or a raw signal. This raw signal can originate from one, but preferably several sensors. Using the concrete example of an EKG system, typical EKG sensors can be combined with sensors for the temperature, activity sensors, such as acceleration sensors and sensors for ambient data, such as location, light or acoustic sensors. A combination with GPS data from a GPS module is also possible. The raw data can be composed of any combination of data from the aforementioned or other sources.

A first possibility of aggregation lies in the change of the resolution stage. Thus, data compression can take place which is preferably morphology-maintaining. This means especially that a data reduction preferably does not lead to relevant information, such as, for example, maxima, peaks or irregularities being lost.

Aggregation typically takes place at the end of a closed time interval. Time intervals are hierarchically ordered and more or less strictly staggered: For the human observer, interval stages of daily life are especially suited (for example, minutes, hours, days, weeks, months, years, etc.), for rather technical considerations intervals with logarithmic staggering, for example, 1, 10, 100, 1000 . . . seconds or 1, 3, 10, 30, 100, 300, . . . or 1, 2, 5, 10, 20, 50, 100, . . . . Preferably therefore, more than one, especially preferably two, three, four or more aggregation stages corresponding to data are present at the same time in the user device or are stored at the same time.

In addition to different possibilities for choosing aggregation stages or resolution stages, different aggregation methods can be used and/or combined. Relative to this exemplary embodiment of an EKG system, aggregation can take place, for example, by determining parameters, such as the heart rate or normal beat intervals. One possibility of aggregation, here, lies in using analysis methods as such for determining heart rate variability especially via different resolution stages. Furthermore, it is possible to use an aggregation based on analyses for determining arrhythmias.

For an aggregation, especially in a respective resolution interval, events can be counted and minima and maxima can be formed. Furthermore, it is possible to determine the standard deviation, the median, distribution curves or the zero, first, or second instant. Other possibilities constitute so-called outliers. The aggregation, the aggregation depth and/or the resolution stage can, furthermore, be made dependent on other criteria, such as the activity or the location of a patient.

For an evaluation, especially in or by the evaluation device, the especially aggregated data can be displayed in the form of a signal display. Curves of the average heart rates or tachograms can take place both classically, and also with respect to the standard deviation or with reference to frequencies of special events. An evaluation capacity can also arise by a pixel-based or graph-based visualization, preferably by a color-augmented histogram. Preferably, methods in accordance with the invention enable an interactive navigation by the especially aggregated data. Thus, time visualization can take place, especially with respect to the frequency of events and the availability of information. Preferably, interactive navigation begins with a survey display and a selection of region of special interest, especially of time intervals. It is also possible to define filter criteria, for example, threshold values or logic operations. All the aforementioned signal displays can be used singly or in any combination with one another.

Furthermore, there are the most varied possibilities of display. In particular, the tachogram, time-adjusted graph superpositions or parallel positions or the frequency of certain events can be displayed. They can be visualized especially depending on the aggregation stage by X-Y graphs, bar, bubble, pulse plots, 2D graphs, 3D graphs and/or pixel representations such as for example heat maps.

Attributes can be, for example, colors, intensities, and/or saturations as well as shapes and glyphs.

For interactive navigation through the data, which are preferably stored in aggregated form on the user device, the drill-down method can also be used. For this purpose, preferably, interesting regions of the especially aggregated data are identified, marked and/or selected and are displayed in another, especially improved resolution stage or lower aggregation stage. Identification takes place preferably by a physician or by the evaluation device.

In one specific example, in conjunction with an EKG system in accordance with the invention, via a corresponding sensor, the electrical activities of the heart muscle fibers are recorded and stored by a user device as raw data or raw signal. These raw data are aggregated, especially during the current recording. For this purpose, the raw signal is processed, especially in minute intervals, by means of Fourier analysis and a value is determined for the heart rate variability in the respective intervals. In the case of heart rate variability, since a small value tends to be regarded as critical, in a next aggregation stage, a minimum value can be formed over, for example, 10 minutes, and in the following aggregation stages over increasing interval lengths. In this way, an aggregation pyramid is formed using different methods, such as Fourier analysis and the minimum value formation and the choice of different resolution stages to higher aggregation levels. Therefore, it is advantageous when data are present at the same time in several aggregation stages, especially are stored in the user device. In particular, the data are stored in a first aggregation stage, and additionally, in at least one second aggregation stage, preferably in three or more aggregation stages or are produced by a user device.

Preferably, the aggregation takes place in a computer unit of the user device. Furthermore, the data can be retrieved from an external evaluation device. In the specific case, for example, a cell phone link which offers a comparatively low data transmission rate is used for data transmission. The advantages of system mobility predominate especially when the method in accordance with the invention is being used.

The evaluation device requests measurement results from the user device via the data link. As a response to this request, the evaluation device, however, does not receive the raw data, but already aggregated data, in the specific case, for example, the minimum values of heart rate variability with reference to larger time intervals. Thus, only a minimum amount of data need be transmitted and it can be displayed by the evaluation device, for example, as a clear histogram. If one or more intervals engender special interest, additional, more detailed data are requested for these intervals. If several coherent intervals are of interest, the user device will transmit this segment, for example, more detailed by only one aggregation stage. In another case, if only a very small extract or even one interval is chosen, it is possible to skip one or more aggregation stages and likewise transmit a much more detailed view. This principle can be continued until the raw data are transmitted for a domain or extract especially of particular interest. The amount of data and the time necessary for transmission are comparatively small since only a small extract of the raw data need be transmitted.

Alternatively to the request for detailed resolution, it can also be feasible to request data from another aggregation method or another aggregation pyramid for the existing resolution or for an extract therefrom. Thus, according to the invention, after identification of a time segment of interest about the heart rate variability, it is also possible to have an especially aggregated representation of the heart rate displayed. With reference to the heart rate, if the matching aggregation stage should not yet be present, it is possible for the user device to generate it on request and only subsequently send it or to offer the data of another aggregation stage. For example, the aggregation of the heart rate can be its median relative to a corresponding time interval. The transmitted values can be displayed by the evaluation device, for example, in the form of a 2D graph.

Another application scenario for the domestic environment relates to so-called “activities of daily life.” The use of the invention in this domain, otherwise, acquires inherently inventive importance. Using signals of energy consumption sensors, presence sensors and other sensors, individual behavior profiles can be recognized. This information is possibly worth protecting and can be further used only with the assent of the affected parties. Technical protection against confiscation and abuse can therefore be provided. In particular, the system, the user device and/or the evaluation device, can be made to especially prevent unauthorized or abusive accesses, to authenticate an access and/or an evaluation device and/or to encrypt data.

Long-term data recordings are, for example, proper and advantageous, on the one hand, for optimizing individualized emergency detectors which are sensitive to deviation from the “individually typical,” and on the other hand, for hypothesis generation and findings of possible creeping behavior change processes which can be statistically proven. In either or both cases, the retrospective availability of long-term time series for the quality of the result can be decisive. A latent recording and/or proper preparation of data protected against abuse in the intelligent DataStore is especially preferable.

Another application example, which can also be independently implemented, relates to an intelligent electricity meter. An intelligent electricity meter can be made as a user device, in the sense of this invention, to carry out one or more aggregation methods. For example, by a power sensor or the like, power consumption can be determined by the intelligent electricity meter and can be processed and stored by a computer unit of the electricity meter using an aggregation method. In this way, it is possible to store a detailed time characteristic of the power consumption and/or aggregated data in the user device or in the intelligent electricity meter. In addition to the generally known properties of an intelligent electricity meter, this enables the possibility of also using the initially described drill-down technique here and of requesting detailed data, especially in steps. Thus, it is possible to detect, for example, with an aggregation method, faults such as fault currents or the like and to subsequently retrieve information in a higher degree of detail even if they relate to a time before the fault event.

Detailed data about the power consumption of consumers on a corresponding power grid can be sensitive since conclusions about the user behavior are possible. Therefore, it can be preferred that an access to nonaggregated data or data with a higher degree of detail is only possible on site for fault analysis. Alternatively or additionally, encryption or other methods for access security can be provided.

According to this invention, the described aspects can be implemented both individually or also in any combination. Other aspects, advantages, features and properties of this invention will become apparent from the following description of a preferred exemplary embodiment with reference to the accompanying drawings.

### BRIEF DESCRIPTION OF THE DRAWINGS

FIG. 1 is a schematic of a system in accordance with the invention and

FIG. 2 is a schematic of stored data in different aggregation stages.

### DETAILED DESCRIPTION OF THE INVENTION

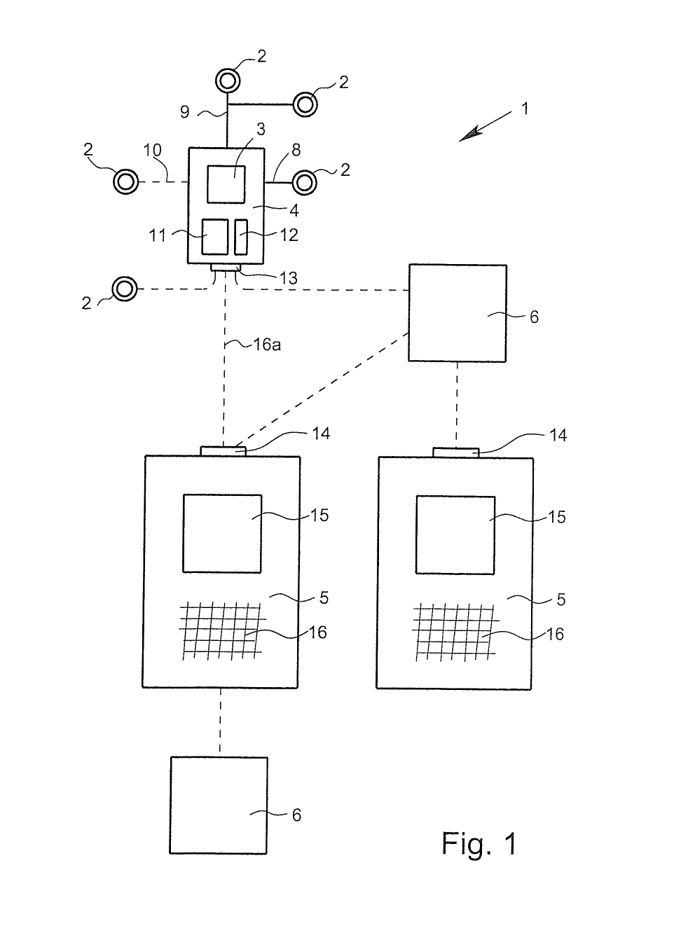

FIG. 1 shows a schematic block diagram of a preferred embodiment of a system 1 in accordance with the invention with sensors 2 and a computer unit 3 which are assigned to a user device 4. Furthermore, the system 1 has an evaluation device 5 and a central site 6. Sensor data from the sensors 2 can be stored by the user device 4. For data transmission, wire connections, such as cables 8 or bus systems 9 can be used. Another possibility is the linking of a sensor 2 to a user device 4 via a radio interface 10. The illustrated user device 4 also has an energy storage 11, such as a battery, a charge monitoring means 12 and an interface 13.

A data link, especially with the evaluation device 5 or the central site 6, can be obtained via the interface 13. Due to their flexibility, radio links are preferred. However, it is also possible in accordance with the invention that a cabled or other data link is established via the interface 13. Preferably, a data link between the interface 13 of the user device 4 and the interface 14 of the evaluation device 5 is established.

The evaluation device 5, preferably, has a display apparatus 15. There is also an input apparatus 16 for controlling the evaluation device 5. This input apparatus 16 is optional and can be replaced especially by a display apparatus 15 which is made such that it has functions of an input apparatus. The evaluation device 5 can retrieve data, especially in an aggregated form, via a data link 16a, from a user device and/or can obtain them from a user device. Preferably, the evaluation device 5 can store data internally or transmit them to a central site 6, especially for archiving.

In the illustrated exemplary embodiment of the system 1, it is provided that the user device 4 can set up a link to central site 6. In this way, the user device 6 can, for example, actively transmit information about a critical state to the central site 6. The central site 6 is furthermore made such that it can transmit data to an evaluation device 5.

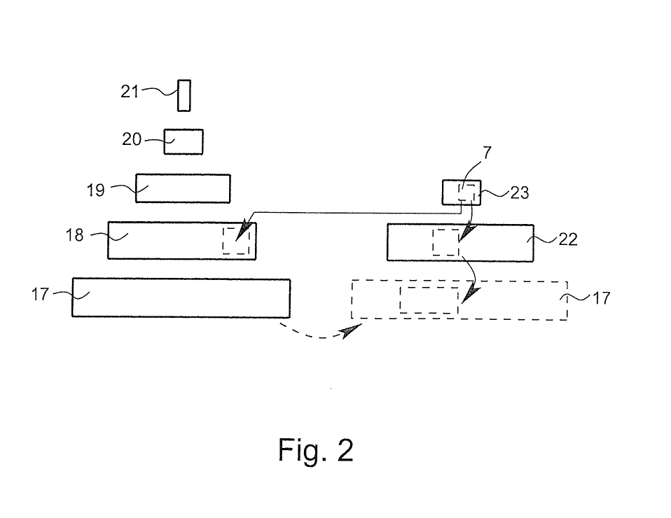

FIG. 2 schematically shows one possible structure of aggregated data. Raw data 17 are preferably aggregated in the user device 4. The result of this first aggregation is that the aggregated data 18 preferably have a reduced data volume. Other aggregations lead to higher aggregation levels or to the aggregated data 19, 20, and 21 which preferably have a decreasing data volume. As a result, in the imaged display, a pyramidal shape arises, the raw data 17 forming the foundation, and with increasing aggregation stages, the data volume in the display decreases leading to the described aggregation pyramid.

Using another aggregation method, it is possible to generate or compute from the raw data 17, aggregated data 22 which deviates from the aggregated data 18, and in turn, the aggregated data 23 therefrom.

An access to the aggregated data will be briefly explained based on this example. A subset 7 of aggregated data 23 can be manually and/or automatically identified as interesting, especially using the evaluation unit 5. In accordance with the invention, this subset 7 can be requested in a more detailed aggregation stage by a subset of the aggregated data 22 which corresponds to the subset 7 being requested by the evaluation device 5.

Alternatively or in addition, it is possible to select the subset 7 of data from the raw data 17 or from another aggregation pyramid. This means especially that data aggregated with another method are retrieved by the evaluation device 5 or are sent to a central site 6. For example, a subset of the aggregated data 18 which corresponds to the subset 7 can be selected and transmitted.

What is claimed is:

1-15. (canceled)

16. Method for storage and evaluation of data, comprising the steps of:
acquiring data via at least one sensor,
storing the acquired data with a computer unit of a user device in a manner enabling the stored data to be retrievable via an external evaluation device,
wherein, in the data storing step, the data are stored by the computer unit of the user device in a hierarchically aggregated form that enables the stored data or data parts to be retrievable from the user device in aggregated form by the evaluation device.

17. Method as claimed in claim 16, wherein the data are stored in said hierarchically aggregated form comprises a first aggregation stage and at least a second aggregation stage.

18. Method as claimed in claim 16, comprising the further step of identifying a subset of the data in an aggregated form as interesting and requesting said subset of data in at least one of a more detailed aggregation stage and another aggregated form by the evaluation device.

19. Method as claimed in claim 18, wherein the requested subset of data is transmitted by the user device to the evaluation device.

20. Method as claimed in claim 16, comprising the further step of retrieving or transmitting the data wirelessly to the evaluation device from the user device in aggregated form.

21. Method as claimed in claim 16, wherein the computer unit in the user device, for performing said aggregation, divides the data acquired into data parts which are assigned to a time interval.

22. Method as claimed in claim 16, wherein the data are aggregated by means of at least one subsampling, statistical analysis, computation of derived signal descriptions, nonlinear transforms, especially FFT, DCT, wavelet transform, compressive thinning-out, and machine learning.

23. Method as claimed in claim 16, wherein the user device comprises a power storage unit and wherein the computer unit selects at least one of an aggregation method and a number of aggregation methods to be carried depending on a charged state of the power storage unit of the user device.

24. Method as claimed in claim 16, wherein the data are aggregated by means of machine learning methods based on at least one of historical data and interactive exploratory data mining methods.

25. System for evaluation of data comprising:
at least one sensor for detecting data,
at least one user device that is adapted for retrieving detected data from said at least one sensor,
an external evaluation device, and
means for enabling communication between the at least one user device and the external evaluation device,
wherein the at least one user device comprises a computer unit and data storage,
wherein the computer unit is adapted for storing retrieved detected data in said data storage in hierarchically aggregated form and for enabling the stored data or data parts thereof to be retrieved in aggregated form by the evaluation device.

26. System as claimed in claim 25, further comprising at least one of authentication means or data encryption means in at least one of the user device and the evaluation device for avoid unauthorized access to the data.

27. User device for acquisition of data, comprising:
at least one sensor for acquisition of data,
a computer unit adapted for retrieving detected data from said at least one sensor and being adapted for storing the detected in hierarchically aggregated form and in a manner enabling the data to be retrieved in aggregated form by an evaluation device.

28. User device as claimed in claim 27, further comprising a power storage unit for operation thereof.
